(19) United States
(12) Patent Application Publication
(10) Pub. No.: US 2017/0098388 A1
(43) Pub. Date: Apr. 6, 2017

(54) Back to Basics Multiplication Blocks

(71) Applicant: Gloria Verdieu, San Diego, CA (US)

(72) Inventor: Gloria Jean Verdieu, San Diego, CA (US)

(73) Assignee: Gloria Verdieu

(21) Appl. No.: 14/876,271

(22) Filed: Oct. 6, 2015

(51) Int. Cl. G09B 19/02

(52) U.S. Cl. CPC G09B 19/02

(57) ABSTRACT

Multiplication Blocks are for the whole family from toddlers, preschoolers, kindergarten, parents, aunts and uncles teaching children the concept of counting, adding, grouping, leading up to multiplying and dividing whole #'s 1-12.

Most elementary school children carry a multiplication matrix in their folders. Multiplication blocks can be used with this or just as it is. Numbers on individual blocks are big enough for toddlers to recognize for simple 1, 2, and 3 digit number recognition. The case comes with three removable blocks that are relatively easy for preschoolers to keep up with. Removable blocks are easily manipulated. These blocks, overall is a tool that is useful for Teaching, learning and conceptualizing Multiplication principles.

### BACKGROUND OF INVENTION

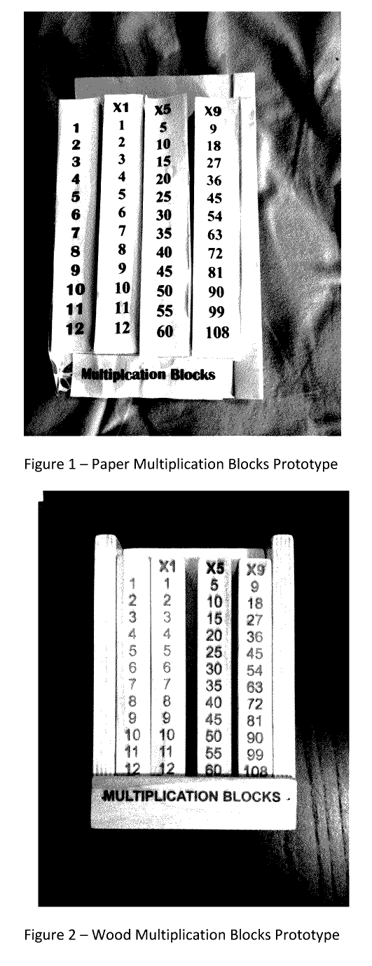

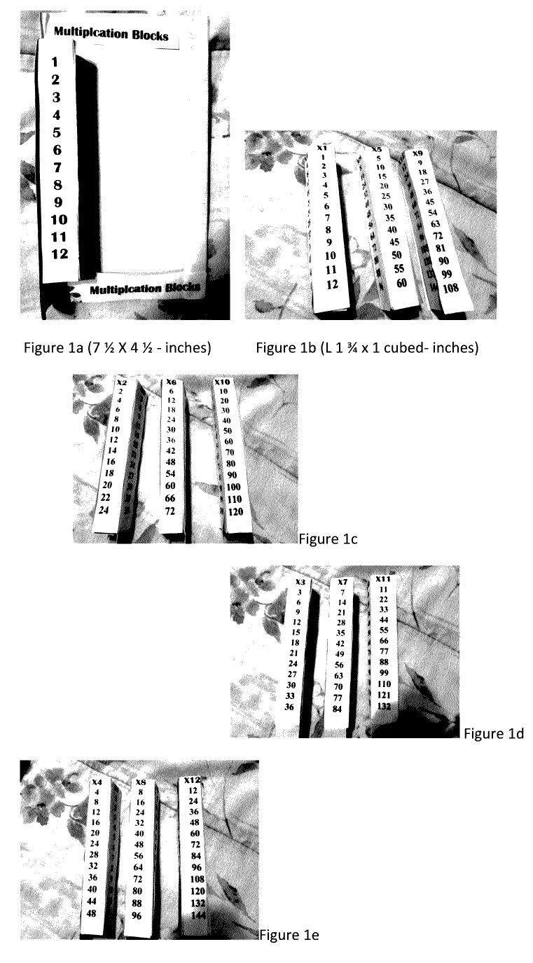

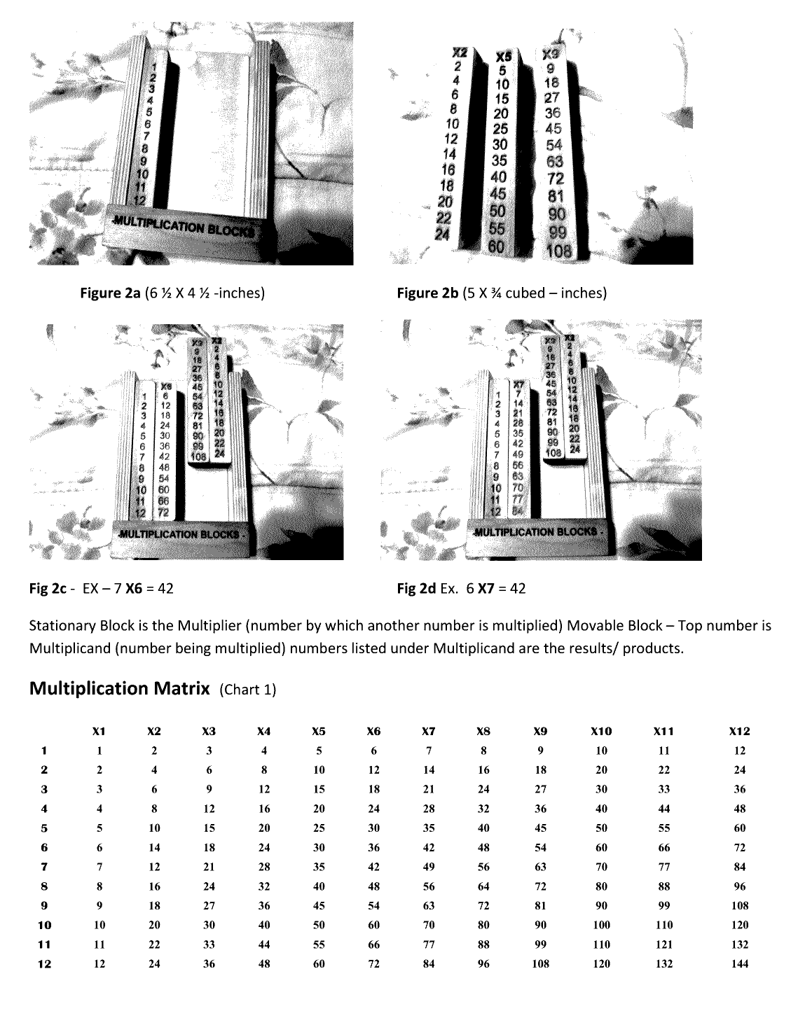

This tool to use for simply multiplying whole numbers is an idea that I have thought about for a long time. The picture became so clear in my head that I picked up pencil and paper and wrote down the multiplication tables from 1 to 12 in four sets. I made my first model with note book paper. I folded one sheet for the holder and 4 additional sheets were folded into 4 sided rectangular blocks. One block has numbers 1-12 on one side. The numbers on this block are the Multipliers. I glued that block to the side of the paper to make it stationary. I folded the paper from the bottom to make space to hold the remaining 3 blocks. I typed the numbers of the multiplication table from 1 to 12 on my computer using excel, printed them out and glued individual rows from the table on the four sides of the 3 remaining blocks. The numbers on the top of these blocks are the Multiplicand and the numbers listed are the products. This paper prototype is shown in FIGS. 1 image on specification sheet #1. I took this paper prototype to the Maker Place in San Diego, where I instructed one of the wood work specialists to construct a second prototype using the paper prototype as a model, out of wood which is much closer to what I envisioned. This Wood prototype is shown in FIG. 2 in the image specification sheets.

I sat with my granddaughter who is learning the concept of multiplication and right away she was able to find the products of any two numbers using Multiplication Blocks and she also liked the design.

Back to Basics Multiplication Blocks, a tool for toddlers, pre-school through elementary to learn Multiplication tables 1-12.

There are many educational tools that use blocks to help children learn mathematical functions. I have cited 4 in particular that could be viewed as similar to this one.
G09B19/02
   8.757.620—Teaching aids using a mathematical matrix
   7.549/865—Mathematics manipulative board
   9.017.077—Block learning Game
   5.098.301—Multiplication facts learning aid

### BRIEF SUMMARY OF INVENTION

Four Cubed Blocks in a case with numbers engraved or stenciled on them. One block is stationary (glued to the case). The other 3 blocks are removable- easily slid in and out of the case. The stationary block has one side with numbers 1-12. This block is the ‘multiplier.’ The remaining 3 blocks have 4 rows of numbers, a row on each side. The first number on the top of the 4 rows of numbers on each block (X#) is the Multiplicand or the number being multiplied. The remaining numbers listed in the rows are the results or the products of the number on the top (multiplicand) and the (multiplier).

Stationary Block 1

1 2 3 4 5 6 7 8 9 10 11 12

Block 2

X1 - 1 2 3 4 5 6 7 8 9 10 11 12
X2 - 2 4 6 8 10 12 14 16 18 20 22 24
X3 - 3 6 9 12 15 18 21 24 27 30 33 36
X4 - 4 8 12 16 20 24 28 32 36 40 44 48

Block 3

X5 - 5 10 15 20 25 30 35 40 45 50 55 60
X6 - 6 12 18 24 30 36 42 48 54 60 66 72
X7 - 7 14 21 28 35 42 49 56 70 77 84 63
X8 - 8 16 24 32 40 48 56 64 72 80 88 96

Block 4

X9 - 9 18 27 36 45 54 63 72 81 90 99 108
X10 - 10 20 30 40 50 60 70 80 90 100 110 121
X11 - 11 22 33 44 55 66 77 88 99 110 121 132
X12 - 12 24 36 48 60 72 84 96 108 121 132 144

### BRIEF DESCRIPTION OF THE DRAWINGS

1. Image Sheet #1
a. FIG. 1—Multiplication Blocks made of notebook paper—first prototype
b. FIG. 2—Multiplication Blocks made of wood—second prototype

2. Images Sheet #2
a. FIG. 1a—Multiplication Block case made of notebook paper (7½×4½ inches)
b. FIG. 1b—one of the 4 sides of the movable blocks (6½×1 inch cubed)—×1,×5×9
c. FIG. 1c—one of the 4 sides of the movable blocks (6½×1 inch cubed)—×2,×6,×10
d. FIG. 1d—one of the 4 sides of the movable blocks (6½×1 inch cubed)—×3,×7,×11
e. FIG. 1e—one of the 4 sides of the movable blocks (6½×1 inch cubed)—×4,×8,×12

3. Images Sheet #3
a. FIG. 2a—Multiplication Block case made of wood (6¼×4½ inches)
b. FIG. 2b—one of the 4 sides of the movable blocks (5×¾ inch cubed)—×2,×5×9
c. FIG. 2c—example using block to calculate—7×6=42
d. FIG. 2d—example using block to calculate—6×7=42
e. Chart 1—Multiplication Matrix 1-12 (Excel worksheet)

### DETAILED DESCRIPTION OF INVENTION

### Construction:

1^{st} Prototype—paper construction—folded 4 pieces of paper into cubed blocks, typed the numbers of the multiplication table from 1 to 12 on my computer using excel, printed them out and glued individual rows from the table on one side of block one and four sides of the 3 remaining blocks. I made a paper case, glued stationary block with numbers 1-12 on the left edge of case and folded bottom to use as a holder for the three remaining removable blocks.

2^{nd} Prototype—Wood construction—took paper design to Maker Place wood shop and instructed wood specialist to construct model using wood. Used wood to cut back plane and sides and cut 4 wood blocks into 5½×¾ cubed blocks for stationary and removable blocks. Used Laser to engrave numbers on individual blocks and letters on base, and used Wood glue to attach permanent block to case.

Using Back to Basics Multiplication Block to Multiply 2 numbers:

Place the removable Block with the number being multiplied next to the Stationary Block. Align the results/ products on the loose block with the the row of numbers on the stationary block. Refer to FIGS. 2c & 2d

Starting at the top of the stationary block scroll down to the number of times the number on the top of the loose block is being factored or multiplied by. The result or product is the number on the loose block adjacent to the number on the stationary block.

### EXAMPLE: See FIGS. 2c & 2d

7×6 Choose block with ×5-×5-×7-×8

Align side with ×6 result or product numbers with the Stationary Block

Scroll down to number 7 on the stationary block and the answer is the corresponding number on the ×6 loose block (42).

6×7

Align side with ×7 result or product numbers with the Stationary Block

Scroll down to number 6 on the stationary block and the answer is the corresponding number on the ×6 loose block (42).

Back to basic Multiplications blocks are for the whole family. Multiplication tables are committed to memory. When children ask what is 7×9? We don't add number 9 seven times we just know it is 63. 7×9=9×7 can be easily shown with Back to Basics multiplication blocks.

1. Begin with individual blocks and learning Multiplication Tables & Charts
Count 1-12
Sequential counting adding number to itself 1+1+1 . . . 12, 2+2+2 . . . 24, 3+3+3 . . . 36 and so forth . . . 12+12+12 . . . 144
Counting by 2's, 3's, 4's . . . Up to 12
Multiplying whole numbers 1-12
Concepts 1×2=2×1
Multiplication: Use factors—multiplier, multiplicand; Product (Result)
Division: Use Product (Result)—multiplier, multiplicand; factors
